(19) United States
(12) Patent Application Publication
(10) Pub. No.: US 2010/0171789 A1
(43) Pub. Date: Jul. 8, 2010

(54) NOZZLE CAPPING DEVICE OF INKJET PRINTER

(75) Inventors: Il-jun MUN, Suwon-si (KR); Karp-sik YOUN, Hwaseong-si (KR); Sung-wook KANG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/570,061

(22) Filed: Sep. 30, 2009

(30) Foreign Application Priority Data
Jan. 6, 2009 (KR) 10-2009-0000846

(51) Int. Cl. B41J 2/165

(52) U.S. Cl. 347/31; 347/29

(57) ABSTRACT

Provided is a nozzle capping device of an inkjet printer including a cap covering a nozzle chip of an inkjet head, and a humidity supply unit supplying humidity to an inner space formed by the cap covering the nozzle chip and the inkjet head.

### CROSS-REFERENCE TO RELATED APPLICATIONS

This application claims priority under 35 U.S.C. §119(a) of Korean Patent Application No. 10-2009-0000846, filed on Jan. 6, 2009, in the Korean Intellectual Property Office, the disclosure of which is incorporated herein in its entirety by reference.

### BACKGROUND

1. Field of the Invention

The present general inventive concept relates to a nozzle capping device of an inkjet printer that prevents a nozzle for ejecting ink droplets from being dried and clogged.

2. Description of the Related Art

In general, an inkjet printer is a printing device that prints predetermined images by ejecting ink droplets onto desired locations on a printing medium and can be classified as either a shuttle type inkjet printer or an array type inkjet printer. A shuttle type inkjet printer includes a print head including a single nozzle chip, and prints by reciprocally moving the print head along the width direction of a printing medium. An array type inkjet printer includes a plurality of nozzle chips arranged along the width direction of a printing medium, and prints line by line. Recently, printers having an array type head are preferred due to increased printing speeds.

Meanwhile, if printing jobs using an inkjet print head have not been performed for a long period of time, ink in a droplet ejection hole of a nozzle chip, i.e., a nozzle, may dry, and thus the nozzle may become clogged. In this case, droplets are not ejected from the nozzle, preventing a clear color image from being printed. Thus, an inkjet printer includes a capping device that covers the nozzle chip so as to prevent the nozzle chip from being exposed to external air while printing jobs are not being performed. The capping device surrounds and covers the nozzle chip of the inkjet print head so that ink in the nozzle does not dry and solidify due to the nozzle chip being exposed to external air, similar to a cap of an ink pen.

However, it is difficult to completely prevent ink from becoming dry by merely covering the nozzle chip. In particular, since the array type inkjet printer having the plurality of nozzles chips arranged along the width direction of a printing medium has recently been preferred, it is required to increase the size of the capping device in order to wholly cover an array type inkjet print head, which conventionally may fail to tightly seal the inkjet print head and dries the nozzle faster than expected due to a gap between the capping device and the nozzle. Thus, a capping device needs to stably prevent a nozzle from being dried even when printing jobs have not been performed for a long period of time.

### SUMMARY

The present general inventive concept provides a nozzle capping device of an inkjet printer including a cap covering a nozzle chip of an inkjet head and a humidity supply unit to supply humidity to an inner space formed by the cap covering the nozzle chip and the inkjet head.

Additional features and utilities of the present general inventive concept will be set forth in part in the description which follows and, in part, will be obvious from the description, or may be learned by practice of the general inventive concept.

The humidity supply unit may include a storage unit to store a liquid and a connection tool connected to the storage unit to supply the humidity to the inner space formed by the cap and the inkjet head.

The connection tool may include a connection unit to selectively connect the inner space formed by the cap and the inkjet head and a connection hole formed in the storage unit to connect the inner space formed by the cap and the inkjet head and the storage unit.

The connection unit may include a pin valve to elastically close the connection hole, wherein, when the cap covers the nozzle chips, the pin valve is elastically pushed against by the inkjet head and thus the connection hole is opened.

The connection unit may include a slider to slidably move and close the connection hole, wherein, if the slider slidably moves, the hole is opened and thus the inner space formed by the cap and the inkjet head and the storage unit is connected to each other.

The liquid may be one selected from the group consisting of water and non-color ink.

The storage unit may be one selected from the group consisting of a case formed of a hard material, a flexible bag that expands and contracts, and a porous unit that sponges up liquid.

The storage unit may include a remnant detecting sensor to measure remaining amounts of liquid in the storage unit.

The nozzle capping device may further include a liquid supplementing unit to supplement more of the liquid into the storage unit according to a signal generated by the remnant detecting sensor.

The nozzle capping device may further include a hygrometer to measure the humidity of the inner space formed by the cap and the inkjet head.

Embodiments of the present general inventive concept further include a nozzle capping device of an image forming apparatus, including a printhead with a plurality of nozzle chips to eject ink therefrom, and a capping unit to provide continuous humidity to the plurality of nozzle chips when capping the nozzle chips.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a view of an external appearance of a nozzle capping device according to an exemplary embodiment of the present general inventive concept;

FIG. 2 is an exploded perspective view of the nozzle capping device of FIG. 1;

FIGS. 3A and 3B are views for illustrating an operation of (pin valves of) the nozzle capping device of FIG. 1; and

FIGS. 4 and 5 are views of a nozzle capping device according to exemplary embodiments of the present general inventive concept.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

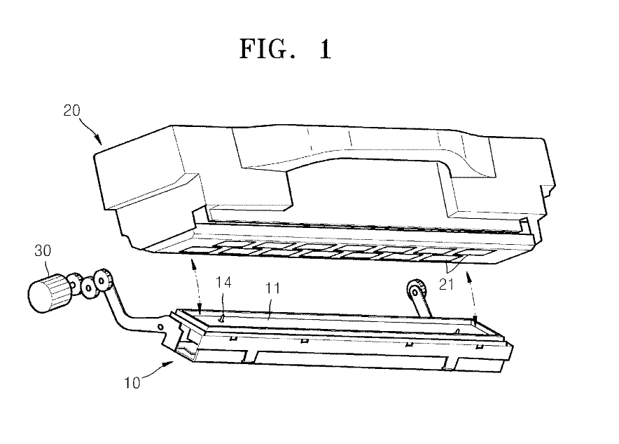

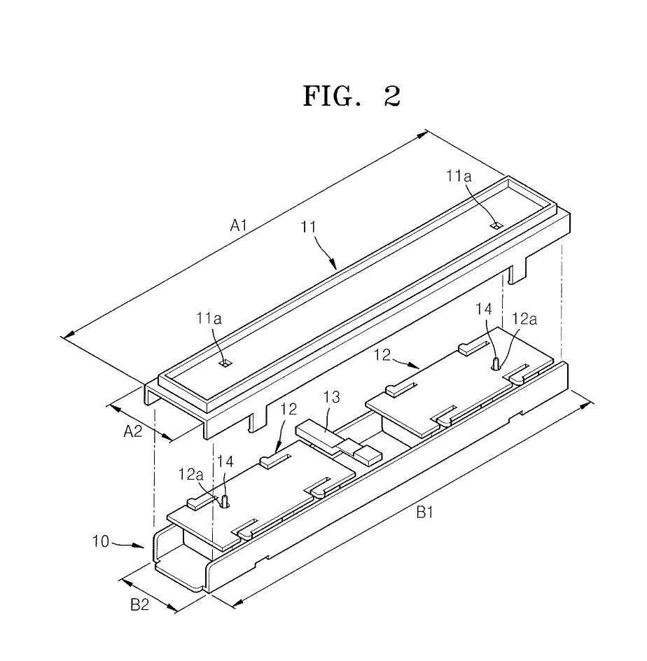

FIGS. 1 and 2 are views of a nozzle capping device according to an exemplary embodiment of the present general inventive concept.

Referring to FIG. 1, the nozzle capping device of the present general inventive concept includes a body 10 that may rotate according to a motor 30 and a cap 11 installed in an upper surface of the body 10. If the body 10 is rotated toward a print head 20 by the motor 30, the cap 11 may cover a plurality of nozzle chips 21 disposed on a lower surface of the print head 20 to form an inner space, preventing the nozzle chips 21 from exposure to external air.

Referring to FIG. 2, the body 10 may include two storage units 12 in which a liquid, such as water or non-color ink, may be stored. Two connection holes 11a may be formed in the cap 11 and one connection hole 12a may be formed in each of the two storage units 12 such that a space is formed in the storage units 12 and the cap 11. Thus, if the connection holes 11a and 12a are opened, the liquid stored in the storage units 12 may evaporate into the inner space formed by the cap 11 and the print head 20. In more detail, when the inner space is formed around the nozzle chips 21, a humidity supply unit including the storage units 12 may supply humidity to the inner space, thereby preventing a nozzle of the nozzle chips 21 from being clogged.

FIG. 2 also illustrates the length A1 and width A2 of cap 11 and the length B1 and width B2 of body 10.

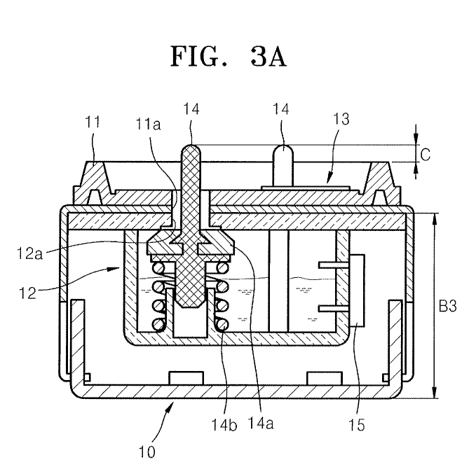

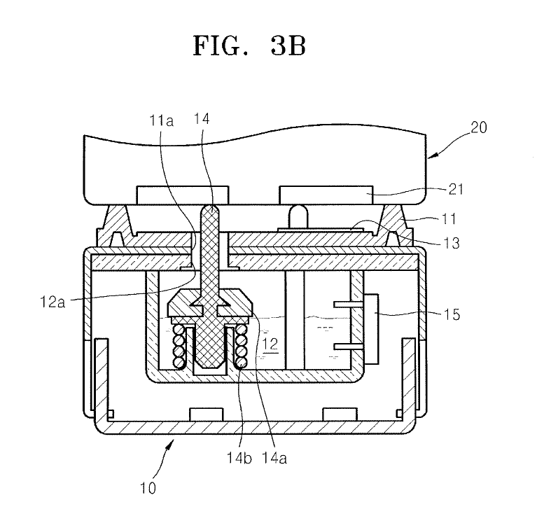

Two pin valves 14 may be used to elastically cover the connection holes 11a and 12a and function as connection units. When the body 10 is spaced apart from the print head 20, the pin valves 14 may close the connection holes 11a and 12a. When the body 10 approaches the print head 20 to allow the cap 11 to cover the nozzle chips 21, the pin valves 14 may open the connection holes 11a and 12a. FIGS. 3A and 3B are views for explaining an operational mechanism of the pin valves 14. Referring to FIG. 3A, when the body 10 of the nozzle capping device is separated from the print head 20, the pin valves 14 may rise due to the elasticity of springs 14b and thus the connection holes 11a and 12a may be closed by packing units 14a. Referring to FIG. 3B, when the body 10 approaches the print head 20, the pin valves 14 may be pressed by the print head 20, which compresses the springs 14b, and thus the connection holes 11a and 12a closed by the packing units 14a may be opened. A remnant detecting sensor 15 may be used to detect remaining amounts of the liquid stored in the storage units 12. A hygrometer 13 may also be used to measure the humidity of the inner space.

FIG. 3A also illustrates the height B3 of body 10. Further, distance C illustrated in FIG. 3A constitutes the distance which pin valves 14 extend from beyond cap 11 when the body is not pressed against print head 20.

A method of operating the nozzle capping device of the present exemplary embodiment will now be described.

When a printing job is performed, the body 10 of the nozzle capping device may be spaced apart from the print head 20 in order for nozzles of the nozzle chips 21 to normally eject ink onto a sheet (not illustrated).

In a printing standby state after the printing job is completed, the body 10 may approach the print head 20 according to the driving of the motor 30 and thus the cap 11 may surround and cover the nozzle chips 21 to form the inner space with the print head 20, preventing the nozzle chips 21 from exposure to external air. The pin valves 14 may be pressed by the print head 20, and thus the connection holes 11a and 12a closed by the packing unit 14a may be opened, as illustrated in FIG. 3B. Thereafter, the liquid stored in the storage units 12 may naturally evaporate such that humidity is continuously supplied to the inner space formed by the cap 11 and the print head 20, which moistens each nozzle of the nozzle chips 21 and prevents ink in the nozzles of the nozzles chips 21 from drying. The hygrometer 13 may measure the humidity of the inner space. If the humidity is below a proper level, an alarm message can be displayed on a display panel of an inkjet printer including the nozzle capping device. The remnant detecting sensor 15 can detect whether the amount of the liquid stored in the storage units is below a proper level. If the amount of liquid is below the proper level, an alarm message can be displayed on the display panel of the inkjet printer. If the alarm message indicating that the amount of liquid or the humidity is below the proper level is displayed on the display panel of the inkjet printer, more of the liquid may be filled into the storage units 12 or the storage units 12 may be replaced with new storage units.

Therefore, the humidity of the inner space that surrounds the nozzle chips 21 can remain constant, thereby stably preventing nozzles from being dried and clogged.

Other exemplary embodiments of the nozzle capping device will now be described.

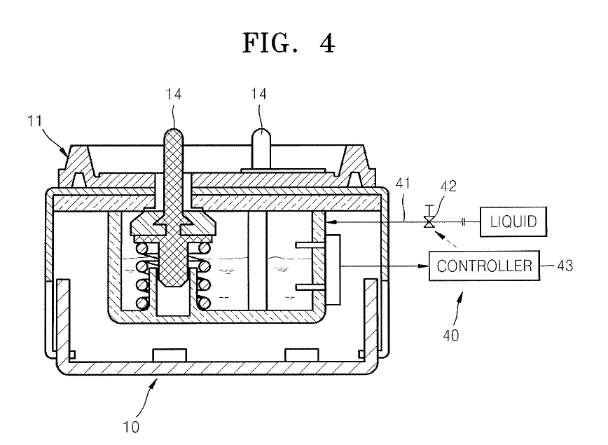

Referring to FIG. 4, the nozzle capping device may further include a liquid supplementing unit 40. The liquid supplementing unit 40 may include a tube 41 that is connected to the storage units 12 and an automatic valve 42 that opens and closes the tube 41 according to a signal generated by the remnant detecting sensor 15. If the remnant detecting sensor 15 detects that the amount of liquid in the storage units 12 is below a proper level, a controller 43 may open the automatic valve 42 to supplement liquid into the storage units 12 through the tube 41, which does need to manually replace the storage units 12 or supplement liquid, thereby providing user convenience.

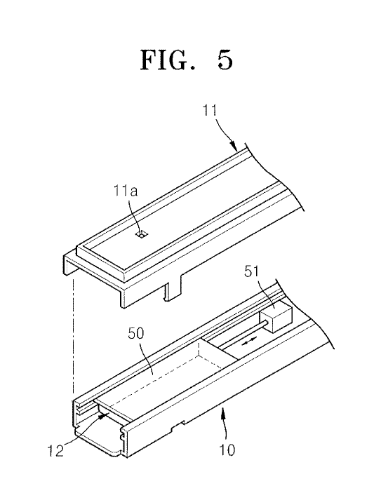

Referring to FIG. 5, in another exemplary embodiment of the present general inventive concept, a connection unit of a connection tool, such as the pin valves 14, may be a slider 50. In more detail, the connection holes 11a may be closed by the slider 50, and when the cap 11 covers the nozzle chips 21, the slider 50 may move according to an actuator 51 to make the connection holes 11a open.

In the present embodiment, the storage units 12 may be cases formed of a hard material including a liquid storage space. For example, a plastic material may be used as the hard material. However, the storage units 12 may be flexible bags that flexibly expand and contract. A film material such as vinyl may be used as a material of the flexible bag. The film material may be sufficiently durable so that air or liquid does not leak. The flexible bag formed of the film material may store liquid. In addition, the storage units 12 may also be porous members containing liquid. A sponge may be used as a material of the porous member. The porous member formed of the sponge may be used as a storage unit by sponging up water or non-color ink.

Therefore, the nozzle capping devices of the above exemplary embodiments can sufficiently prevent nozzles from being clogged by continuously supplying humidity to an inkjet printer even when printing jobs have not been performed for a long period of time, thereby achieving a stable performance of the inkjet printer.

While the present general inventive concept has been particularly illustrated and described with reference to exemplary embodiments thereof, it will be understood by one of ordinary skill in the art that various changes in form and details may be made therein without departing from the spirit and scope of the present general inventive concept as defined by the following claims.

What is claimed is:

1. A nozzle capping device of an inkjet printer comprising:
a cap covering a nozzle chip of an inkjet head; and
a humidity supply unit to supply humidity to an inner space formed by the cap to cover the nozzle chip and the inkjet head.

2. The nozzle capping device of claim 1, wherein the humidity supply unit comprises:
a storage unit to store a liquid; and
a connection tool connected to the storage unit to supply the humidity to the inner space formed by the cap and the inkjet head.

3. The nozzle capping device of claim 2, wherein the connection tool comprises:
a connection unit to selectively connect the inner space formed by the cap and the inkjet head and a connection hole formed in the storage unit to connect the inner space formed by the cap and the inkjet head and the storage unit.

4. The nozzle capping device of claim 3, wherein the connection unit comprises:
a pin valve to elastically close the connection hole,
wherein, when the cap covers the nozzle chips, the pin valve is elastically pushed against by the inkjet head and thus the connection hole is opened.

5. The nozzle capping device of claim 3, wherein the connection unit comprises:
a slider to slidably move and close the connection hole,
wherein, if the slider slidably moves, the hole is opened and thus the inner space formed by the cap and the inkjet head and the storage unit is connected to each other.

6. The nozzle capping device of claim 2, wherein the liquid is one selected from the group consisting of water and non-color ink.

7. The nozzle capping device of claim 2, wherein the storage unit is one selected from the group consisting of a case formed of a hard material, a flexible bag that expands and contracts, and a porous unit that sponges up liquid.

8. The nozzle capping device of claim 2, wherein the storage unit comprises:
a remnant detecting sensor to measure remaining amounts of liquid in the storage unit.

9. The nozzle capping device of claim 8, further comprising:
a liquid supplementing unit to supplement more of the liquid into the storage unit according to a signal generated by the remnant detecting sensor.

10. The nozzle capping device of claim 9, further comprising:
a hygrometer to measure the humidity of the inner space formed by the cap and the inkjet head.

11. A nozzle capping device of an image forming apparatus, comprising:
a printhead with a plurality of nozzle chips to eject ink therefrom; and
a capping unit that provides a continuous humidity to the plurality of nozzle chips when capping the nozzle chips.

12. The nozzle capping device of claim 11, wherein the capping unit comprises:
a storage unit to store liquid to naturally evaporate through a connection hole into a space between the capping unit and nozzle chips when the nozzle chips are capped.

13. The nozzle capping device of claim 12, where the capping unit further comprises:
a pin valve to open the connection hole when the nozzle chips are capped and to close the connection hole when the nozzle chips are not capped.

14. The nozzle capping device of claim 11, wherein the printhead comprises an array type print head.

15. The nozzle capping device of claim 12, wherein the image forming apparatus further comprises:
a display panel to display a message when the humidity in the space is below a proper level.

16. The nozzle capping device of claim 12, wherein the capping unit further comprises:
a hygrometer to detect humidity in the space.
